(19) United States
(12) Patent Application Publication
(10) Pub. No.: US 2006/0104380 A1
(43) Pub. Date: May 18, 2006

(54) Time-switched preamble generation to enhance channel estimation signal-to-noise ratio in MIMO communication systems

(75) Inventors: David P. Magee, Plano, TX (US); Manish Goel, Plano, TX (US); Michael T. DiRenzo, Coppell, TX (US); Michael O. Polley, Garland, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 10/992,403

(22) Filed: Nov. 17, 2004

(51) Int. Cl. H04B 7/02; H04B 7/06

(52) U.S. Cl. 375/267; 375/299; 375/260

(57) ABSTRACT

The present invention provides a channel estimate enhancer for use with a multiple-input, multiple-output (MIMO) transmitter employing N transmit antennas, where N is at least two. In one embodiment, the channel estimate enhancer includes a first preamble generator that produces a basic preamble configured to provide gain training and channel estimation sequences to one of the N transmit antennas during initial time intervals. Additionally, the channel estimate enhancer also includes a second preamble generator, coupled to the first preamble generator, that produces supplementary preambles configured to provide a set of gain enhancing channel estimation sequences to each of (N−1) remaining transmit antennas during (N−1) corresponding sets of subsequent time intervals.

### TECHNICAL FIELD OF THE INVENTION

The present invention is directed, in general, to wireless communication systems and, more specifically, to a channel estimate enhancer, a method of channel estimation and a MIMO communication system employing the enhancer or the method.

### BACKGROUND OF THE INVENTION

Multiple-input, multiple-output (MIMO) communication systems differ from single-input, single-output (SISO) communication systems in that different data symbols are transmitted simultaneously using multiple antennas. MIMO systems typically employ a cooperating collection of single-dimension transmitters to send a vector symbol of information, which may represent one or more coded or uncoded SISO data symbols. A cooperating collection of single-dimension receivers, constituting a MIMO receiver, then receives one or more copies of this transmitted vector of symbol information. The performance of the entire communication system hinges on the ability of the MIMO receiver to establish reliable estimates of the symbol vector that was transmitted. This includes establishing several parameters, which include receiver automatic gain control (AGC) as well as channel estimates associated with the receive signal.

As a result, training sequences contained in preambles that precede data transmissions are employed to train AGCs and establish channel estimates for each receive signal data path. This allows optimal MIMO data decoding to be performed at the MIMO receiver. AGC training and a resulting AGC level typically differ between SISO and MIMO communication systems since the power of the respective receive signals is different. Therefore, a receiver AGC may converge to an inappropriate level for MIMO data decoding if the preamble structure is inappropriate.

For example, a 2×2 MIMO communication system employing orthogonal frequency division multiplexing (OFDM) may transmit two independent and concurrent signals, employing two single-dimension transmitters having separate transmit antennas and two single-dimension receivers having separate receive antennas. Two receive signals Y₁(k), Y₂(k) on the k^{th} sub-carrier/tone following a Fast Fourier Transformation and assuming negligible inter-symbol interference may be written as:
Y₁(k)=H₁₁(k)*X₁(k)+H₁₂(k)*X₂(k)+N₁(k) (1)
Y₂(k)=H₂₁(k)*X₁(k)+H₂₂(k)*X₂(k)+N₂(k) (2)
where X₁(k) and X₂(k) are two independent signals transmitted on the k^{th} sub-carrier/tone from the first and second transmit antennas, respectively, and N₁(k) and N₂(k) are noises associated with the two receive signals.

The channel coefficients Hᵢⱼ(k), where i=1, 2 and j=1, 2, incorporates gain and phase distortion associated with symbols transmitted on the k^{th} sub-carrier/tone from transmit antenna j to receive antenna i. The channel coefficients Hᵢⱼ(k) may also include gain and phase distortions due to signal conditioning stages such as filters and other analog electronics. The receiver is required to provide estimates of the channel coefficients Hᵢⱼ(k) to reliably decode the transmitted signals X₁(k) and X₂(k).

Orthogonal and frequency-switched preamble designs result in concurrent estimation of the MIMO communication channels. However, since these approaches transmit multiple preambles at the same time, a limitation in the signal-to-noise ratio (SNR) associated with providing estimates of the channel coefficients Hᵢⱼ(k) also occurs. For a given analog-to-digital converter (ADC) range, 3 dB to 6 dB may be lost in the estimation process due to concurrent transmission of these preambles. In an attempt to recover some of this lost SNR, symbols in the preamble are often repeated so that these received symbols can be averaged. While effective in recovering some of the lost SNR, data transmission throughput rate is penalized.

Accordingly, what is needed in the art is a more effective way to improve the signal-to-noise ratio (SNR) associated with channel estimation.

### SUMMARY OF THE INVENTION

To address the above-discussed deficiencies of the prior art, the present invention provides a channel estimate enhancer for use with a multiple-input, multiple-output (MIMO) transmitter employing N transmit antennas, where N is at least two. In one embodiment, the channel estimate enhancer includes a first preamble generator that produces a basic preamble configured to provide gain training and channel estimation sequences to one of the N transmit antennas during initial time intervals. Additionally, the channel estimate enhancer also includes a second preamble generator, coupled to the first preamble generator, that produces supplementary preambles configured to provide a set of gain enhancing channel estimation sequences to each of (N−1) remaining transmit antennas during (N−1) corresponding sets of subsequent time intervals.

In another aspect, the present invention provides a method of channel estimation for use with a multiple-input, multiple-output (MIMO) transmitter employing N transmit antennas, where N is at least two. The method includes employing a basic preamble to provide gain training and channel estimation sequences to one of the N transmit antennas during initial time intervals. The method also includes further employing supplementary preambles to provide a set of gain enhancing channel estimation sequences to each of (N−1) remaining transmit antennas during (N−1) corresponding sets of subsequent time intervals.

The present invention also provides, in yet another aspect, a multiple-input, multiple-output (MIMO) communication system employing a MIMO transmitter that has N transmit antennas, where N is at least two, and a channel estimate enhancer that is coupled to the MIMO transmitter. The channel estimate enhancer has a first preamble generator that produces a basic preamble to provide gain training and channel estimation sequences to one of the N transmit antennas during initial time intervals. The channel estimate enhancer also has a second preamble generator, coupled to the first preamble generator, that produces supplementary preambles to provide a set of gain enhancing channel estimation sequences to each of (N−1) remaining transmit antennas during (N−1) corresponding sets of subsequent time intervals. The MIMO communication system also includes a MIMO receiver that has M receive antennas, where M is at least two, and employs the set of gain enhancing channel estimation sequences to determine channel estimates.

The foregoing has outlined preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention.

### BRIEF DESCRIPTION OF THE DRAWINGS

For a more complete understanding of the present invention, reference is now made to the following descriptions taken in conjunction with the accompanying drawings, in which:

FIG. 1 illustrates a system diagram of an embodiment of an N×M MIMO communications system employing channel estimate enhancement that is constructed in accordance with the principles of the present invention;

FIG. 2 illustrates a diagram of an embodiment of a transmission frame format employable with a channel estimate enhancer and constructed in accordance with the principles of the present invention;

FIG. 3 illustrates a diagram of an alternative embodiment of a transmission frame format employable with a channel estimate enhancer and constructed in accordance with the principles of the present invention;

FIG. 4 illustrates a diagram of another alternative embodiment of a transmission frame format employable with a channel estimate enhancer and constructed in accordance with the principles of the present invention, and

FIG. 5 illustrates a flow diagram of an embodiment of a method of channel estimation carried out in accordance with the principles of the present invention.

### DETAILED DESCRIPTION

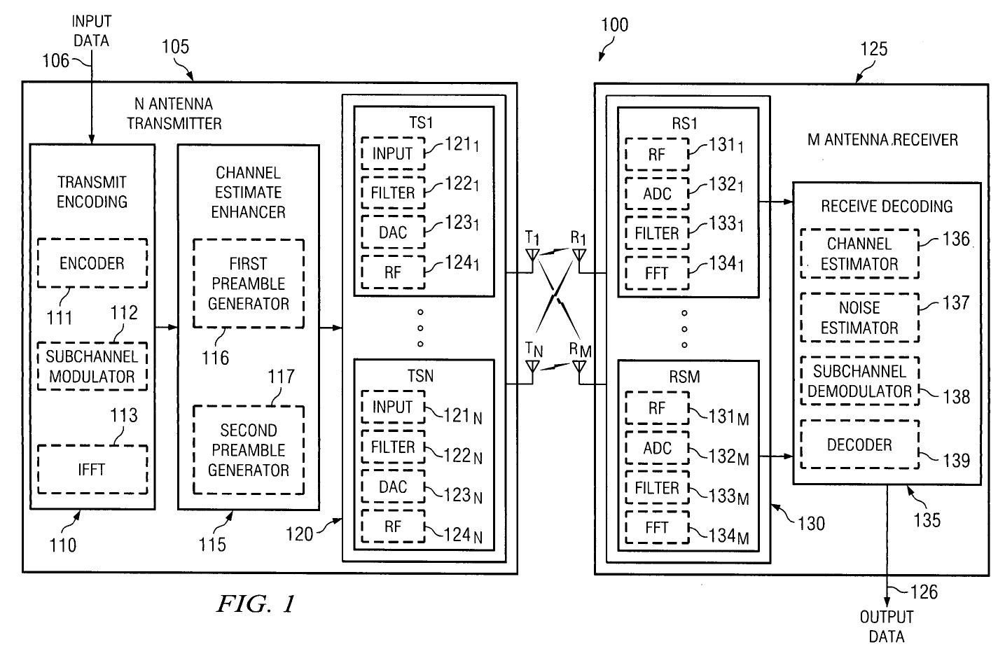

Referring initially to FIG. 1, illustrated is a system diagram of an embodiment of an N×M MIMO communications system, generally designated 100, employing channel estimate enhancement that is constructed in accordance with the principles of the present invention. The MIMO communication system 100 includes a MIMO transmitter 105 and a MIMO receiver 125. The MIMO transmitter 105 employs a data input 106 and includes a transmit encoding system 110, a channel estimate enhancer 115 and a transmit system 120 having N transmit sections TS1-TSN coupled to N transmit antennas T1-TN, respectively. The receiver 125 includes a receive system 130 respectively coupled to M receive antennas R1-RM and a receive decoding system 135 that provides output data 126. In the illustrated embodiment, N and M are at least two.

The transmit encoding system 110 includes an encoder 111, a subchannel modulator 112 and an Inverse Fast Fourier Transform (IFFT) section 113. The encoder 111, subchannel modulator 112 and IFFT section 113 prepare the input data and support the arrangement of preamble information and signal information for transmission by the transmit system 120. The channel estimate enhancer 115 includes a first preamble generator 116 and a second preamble generator 117, which cooperate with the transmit encoding system 110 to generate a time-switched preamble structure. This arrangement employs focused automatic gain control (AGC) training that provides an enhanced communication channel estimation SNR for the receiver 125, which is needed to better process the transmission. Additionally, the first and second preamble generators 116, 117 may be employed in either the frequency or time domain. For the time domain, an IFFT of the appropriate preamble information may be pre-computed and read from memory at the required transmission time.

The N transmit sections TS1-TSN include corresponding pluralities of N input sections 121₁-121_{N}, N filters 122₁-122_{N}, N digital-to-analog converters (DACs) 123₁-123_{N} and N radio frequency (RF) sections 124₁-124_{N}, respectively. The N transmit sections TS1-TSN provide time domain signals, which have proportionally scaled preamble fields, signal fields and data fields for proper packet transmission by the N transmit antennas T1-TN, respectively.

The M receive antennas R1-RM receive the transmission and provide it to the M respective receive sections RS1-RSM, which include corresponding M RF sections 131₁-131_{M}, M analog-to-digital converters (ADCs) 132₁-132_{M}, M filters 133₁-133_{M}, and M Fast Fourier Transform (FFT) sections 134₁-134_{M}, respectively. The M receive sections RS1-RSM employ a proper AGC level to provide a frequency domain digital signal to the receive decoding system 135. This digital signal is proportional the preamble information, signal information and input data. Setting of the proper AGC level is accomplished by establishing a proper ratio between a desired power level and a received power level for a selected ADC backoff level.

The receive decoding system 135 includes a channel estimator 136, a noise estimator 137, a subchannel demodulator 138 and a decoder 139 that employ the preamble information, signal information and input data to provide the output data 126. In the illustrated embodiment, the channel estimator 136 employs a portion of the preamble information for the purpose of estimating the communication channels.

In the channel estimate enhancer 115, the first preamble generator 116 produces a basic preamble that provides gain training and channel estimation sequences to one of the N transmit antennas during initial time intervals. The second preamble generator 117 is coupled to the first preamble generator 116 and produces supplementary preambles that provide a set of gain enhancing channel estimation sequences to each of (N−1) remaining transmit antennas during (N−1) corresponding sets of subsequent time intervals. In the channel estimate enhancer 115, the basic and supplementary preambles employ a time-switched structure that provides null sequences to all other transmit antennas when the set of gain enhancing channel estimation sequences is provided to each of the (N−1) corresponding sets of remaining transmit antennas.

In one embodiment of the present invention, the set of gain enhancing channel estimation sequences employs a supplementary gain training sequence and a supplementary channel estimation sequence. In an alternative embodiment, the set of gain enhancing channel estimation sequences employs a supplementary gain training sequence and two supplementary channel estimation sequences. In embodiments to be illustrated and discussed, the set of gain enhancing channel estimation sequences employs the same set of sequences for each of the (N−1) remaining transmit antennas. Alternatively, a different set of appropriate sequences may also be employed as advantageously directed by a particular application. In yet another embodiment, the basic and supplemental preambles provide orthogonal gain training sequences to each of the N transmit antennas during the same subsequent time interval thereby allowing receiver gains to be reconfigured for concurrent MIMO data reception.

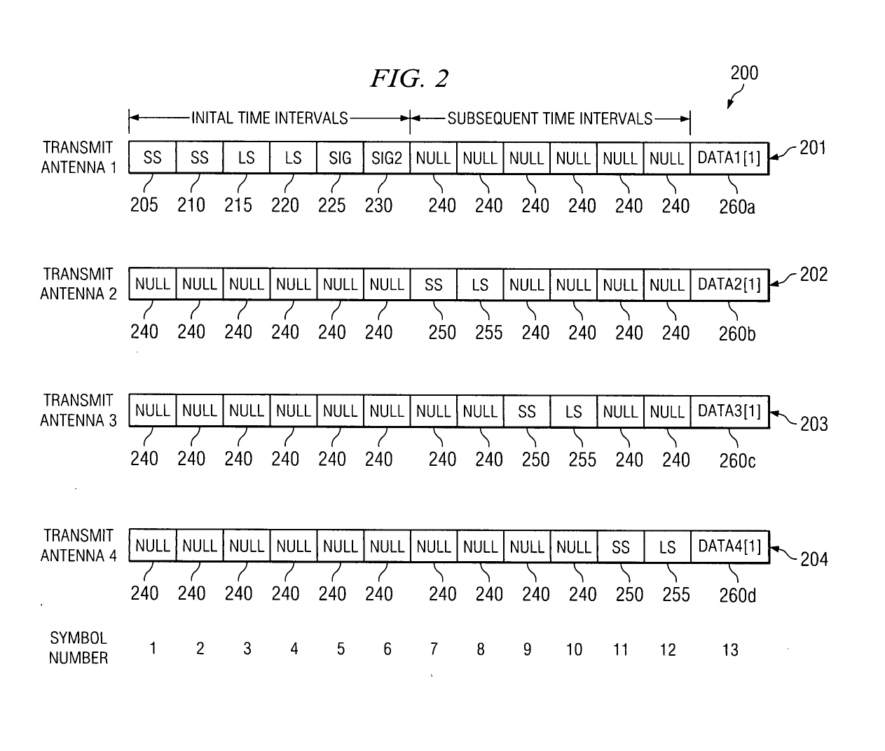

Turning now to FIG. 2, illustrated is a diagram of an embodiment of a transmission frame format, generally designated 200, employable with a channel estimate enhancer and constructed in accordance with the principles of the present invention. The transmission frame format 200 may be employed with a MIMO transmitter having first, second, third and fourth transmit antennas as was generally discussed with respect to FIG. 1, where N is equal to four. The transmission frame format 200 provides a time-switched preamble structure and includes first, second, third and fourth transmission frames 201, 202, 203, 204 associated with the first, second, third and fourth transmit antennas, respectively.

The first transmission frame 201 is a basic preamble that includes first and second gain training sequences 205, 210, first and second channel estimation sequences 215, 220 and first and second signal field sequences 225, 230 that occur during initial time intervals corresponding to symbol numbers 1-6, respectively. In the illustrated embodiment, the first and second gain training sequences 205, 210 and first and second channel estimation sequences 215, 220 of the first transmission frame 201 conform to the IEEE 802.11a standard. A null sequence 240 is also included in the first transmission frame 201 during subsequent time intervals corresponding to symbol numbers 7-12. A first data field 260a is included during symbol number 13, as shown. As may be seen in FIG. 2, both the initial time intervals and the (N−1) subsequent time intervals are contiguous.

In the illustrated embodiment, the use of the null sequence 240 in various positions of the transmission frame format 200 provides results that are substantially equal in their effect although they may employ differing null formats. For example, null sequence 240 may be a zero function that by definition is zero almost everywhere, or it may be a null sequence having a numerical value that converge to zero. Alternatively, the null sequence 240 may be an un-modulated transmission or a transmission employing substantially zero modulation. Of course, the null format of each application of the null sequence 240 may be other current or future-developed formats, as advantageously required by a particular application.

The second, third and fourth transmission frames 202, 203, 204 are supplementary preambles that include only the null sequence 240 during the initial time intervals. The second transmission frame 202 includes a set of gain enhancing channel estimation (GECE) sequences that employs a supplementary gain training sequence 250 and a supplementary channel estimation sequence 255 during symbol numbers 7,8, respectively. The null sequence 240 is included in the second transmission frame 202 during the remaining subsequent time intervals. A second data field 260b is included during symbol number 13.

This general pattern of employing the set of GECE and null sequences during subsequent time intervals continues for the third and fourth transmission frames 203, 204. However, the illustrated set of GECE sequences (250, 255) progresses to later successive time intervals that preserve the transmission mutual exclusivity of the time-switched structure, as shown. The third and fourth transmission frames 203, 204 also include third and fourth data fields 260c, 260d during the symbol number 13.

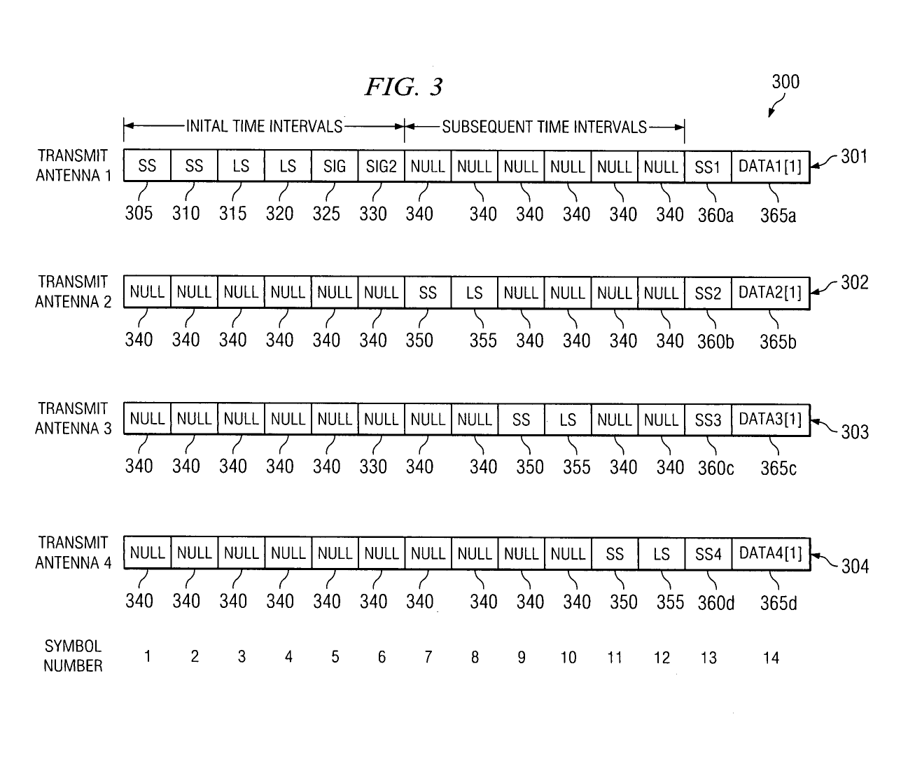

The mutual exclusivity of each set of GECE sequences in the transmission frame format 200 allows AGC gains at a receiver to be increased during channel estimation. This may generally provide a 3 dB to 6 dB channel estimate SNR enhancement. Therefore, addition of the supplementary gain training sequence 250 before the supplementary channel estimate sequence 255 provides an enhanced channel estimate SNR over the SNR-limited situation where multiple preambles are transmitted concurrently. However, a relative AGC gain for each channel estimate is needed to equalize the channel estimates in the MIMO signal processing algorithms. One way to facilitate equalization of the channel estimates is to employ additional concurrent, orthogonal AGC training sequences before transmission of the concurrent MIMO data, which is discussed with respect to FIG. 3, below.

Turning now to FIG. 3, illustrated is a diagram of an alternative embodiment of a transmission frame format, generally designated 300, employable with a channel estimate enhancer and constructed in accordance with the principles of the present invention. The transmission frame format 300 may be employed with a MIMO transmitter having first, second, third and fourth transmit antennas as was generally discussed with respect to FIG. 1 where N is equal to four. The transmission frame format 300 includes first, second, third and fourth transmission frames 301, 302, 303, 304 associated with the first, second, third and fourth transmit antennas, respectively.

The time-switched structure of the first, second, third and fourth transmission frames 301, 302, 303, 304 for the initial and subsequent time intervals is the same as was discussed with respect to the first, second, third and fourth transmission frames 201, 202, 203, 204 of FIG. 2. However, the first, second, third and fourth transmission frames 301, 302, 303, 304 include first, second, third and fourth supplemental gain normalization sequences 360a, 360b, 360c, 360d, which are orthogonal to one another, during the symbol time 13. First, second, third and fourth data fields 365a, 365b, 365c, 365d are also included during symbol time 14.

The supplemental gain normalization sequences 360a-360b are employed to provide adjustment of the existing AGC gains to properly accommodate first, second, third and fourth concurrently transmitted data fields 365a, 365b, 365c, 365d. Since the supplemental gain normalization sequences 360a-360d are both orthogonal and concurrent, they allow restructuring of the receiver AGC gains to values that are correct for concurrent data reception. Therefore, the transmission frame format 300 overcomes having to employ an AGC relative gain as was discussed with respect to the transmission frame format 200.

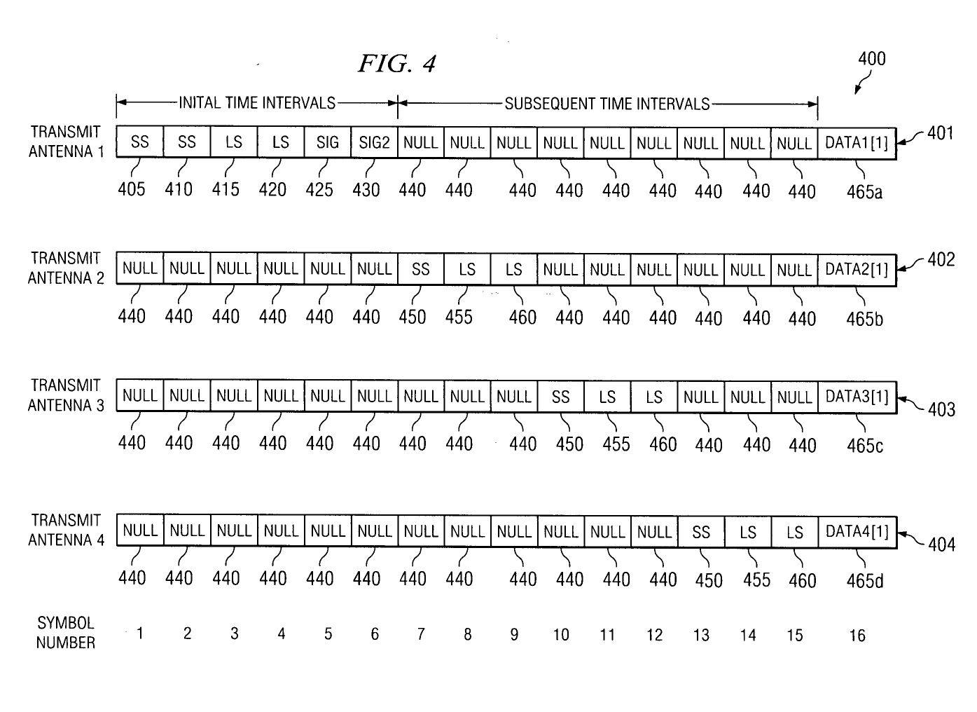

Turning now to FIG. 4, illustrated is a diagram of another alternative embodiment of a transmission frame format, generally designated 400, employable with a channel estimate enhancer and constructed in accordance with the principles of the present invention. The transmission frame format 400 may also be employed with a MIMO transmitter having first, second, third and fourth transmit antennas as was generally discussed with respect to FIG. 1 where N is equal to four. The transmission frame format 400 includes first, second, third and fourth transmission frames 401, 402, 403, 404 associated with the first, second, third and fourth transmit antennas, respectively.

The time-switched structure of the first, second, third and fourth transmission frames 401, 402, 403, 404 for the initial time intervals is again the same as was discussed with respect to the first, second, third and fourth transmission frames 201, 202, 203, 204 of FIG. 2. As may be seen in FIG. 4, the subsequent time intervals portion of the transmission frame format 400 provides a time-switched structure. However, the transmission frame format 400 includes a supplementary gain training sequence 450 along with first and second supplementary channel estimation sequences 455, 460. This additional, second supplementary channel estimation sequence 460 in the set of GECE sequences may be employed in channel estimation symbol averaging to provide yet another enhancement of the channel estimate SNR. The resulting channel estimates would again have to be equalized employing a relative AGC gain, as was discussed with respect to FIG. 2. This particular channel estimate SNR enhancement is provided at the expense of a reduced data throughput, however.

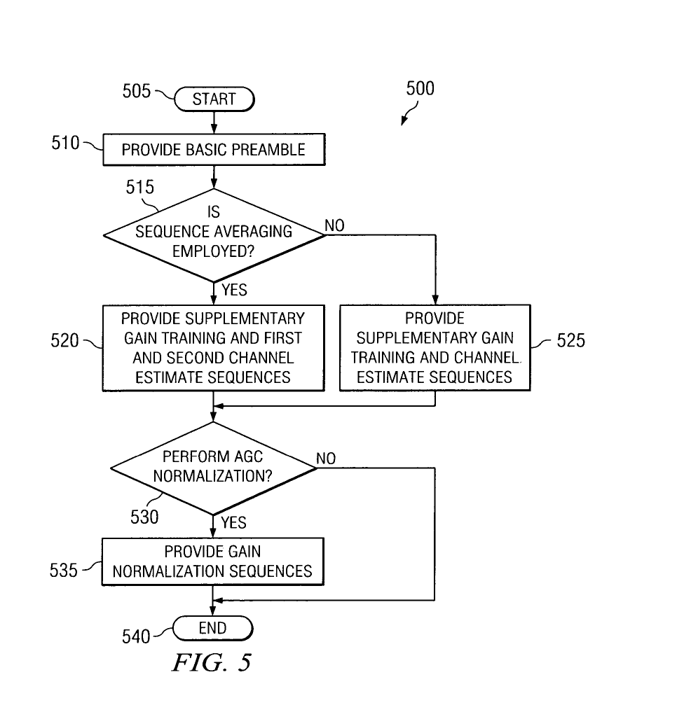

Turning now to FIG. 5, illustrated is a flow diagram of an embodiment of a method of channel estimation, generally designated 500, carried out in accordance with the principles of the present invention. The method 500 may be used with a MIMO transmitter employing N transmit antennas, where N is at least two, and starts in a step 505. Then in a step 510, a basic preamble provides gain training and channel estimation sequences in a time-switched structure to one of the N transmit antennas. In a first decisional step 515, it is determined whether channel estimation sequence averaging is to be employed in providing an improved channel estimation SNR.

If channel estimation sequence averaging is employed, supplementary preambles are provided to the (N−1) remaining transmit antennas in a step 520. The supplementary preambles are organized in a time-switched structure and provide a set of GECE sequences having a supplementary gain training sequence followed by first and second supplementary channel estimation sequences. The supplementary gain training sequence is employed to establish an enhanced AGC gain for improved channel estimation SNR. The first and second supplementary channel estimation sequences are employed to provide sequence averaging, which generally establishes a higher level of channel estimation SNR compared to employing a single supplementary channel estimation sequence.

If channel estimation sequence averaging is not employed in providing channel estimation SNR improvement in the first decisional step 515, then the supplementary preambles provide a set of GECE sequences, organized in a time-switched structure, that employ a supplementary gain training sequence followed by a single supplementary channel estimation sequence, in a step 525. The supplementary gain training and channel estimation sequences provide an improved channel estimation SNR that is typically less than that obtained in the step 520.

In a second decisional step 530, it is determined whether AGC normalization training is to be provided to appropriately accommodate multiple concurrent data transmissions. If AGC normalization training is to be provided, concurrent gain normalization sequences are provided that are orthogonal, in a step 535. In this manner, each receive data path is able to normalize its AGC levels for each channel estimate to a power level that is representative of the data symbols. The method 500 then ends in a step 540. If AGC normalization is not employed in the second decisional step 530, channel estimation equalization is accomplished by employing relative AGC levels for each channel estimate. The method 500 again ends in the step 540.

While the method disclosed herein have been described and shown with reference to particular steps performed in a particular order, it will be understood that these steps may be combined, subdivided, or reordered to form an equivalent method without departing from the teachings of the present invention. Accordingly, unless specifically indicated herein, the order or the grouping of the steps are not limitations of the present invention.

In summary, embodiments of the present invention employing a channel estimate enhancer, a method of channel estimation and a MIMO communication system employing the enhancer or the method have been presented. The channel estimate enhancer is scalable thereby allowing it to accommodate MIMO transmitters having an N of two or more transmit antennas and associated MIMO receivers having an M of two or more receive antennas to more effectively calculate channel estimates. In one embodiment, advantages include trading time slots used to average symbols for improved SNR with additional gain training sequences and providing gain normalization for MIMO data reception. Additionally, the embodiments illustrated are backward compatible with existing IEEE 802.11a systems.

Those skilled in the pertinent art will understand that the present invention can be applied to conventional or future-discovered MIMO communication systems. For example, these systems may form a part of a narrowband wireless communication system employing multiple antennas, a broadband communication system employing time division multiple access (TDMA), orthogonal frequency division multiplex (OFDM) or a general multiuser communication system.

Although the present invention has been described in detail, those skilled in the art should understand that they can make various changes, substitutions and alterations herein without departing from the spirit and scope of the invention in its broadest form.

1. A channel estimate enhancer for use with a multiple-input, multiple-output (MIMO) transmitter employing N transmit antennas, where N is at least two, comprising:
a first preamble generator that produces a basic preamble configured to provide gain training and channel estimation sequences to one of said N transmit antennas during initial time intervals; and
a second preamble generator, coupled to said first preamble generator, that produces supplementary preambles configured to provide a set of gain enhancing channel estimation sequences to each of (N−1) remaining transmit antennas during (N−1) corresponding sets of subsequent time intervals.

2. The enhancer as recited in claim 1 wherein said set of gain enhancing channel estimation sequences employs a same set of sequences for each of said (N−1) remaining transmit antennas.

3. The enhancer as recited in claim 1 wherein said set of gain enhancing channel estimation sequences employs a supplementary gain training sequence and a supplementary channel estimation sequence.

4. The enhancer as recited in claim 1 wherein said set of gain enhancing channel estimation sequences employs a supplementary gain training sequence and two supplementary channel estimation sequences.

5. The enhancer as recited in claim 1 wherein said basic and supplementary preambles employ a time-switched structure that provides null sequences to all other transmit antennas when said set of gain enhancing channel estimation sequences is provided to each of said (N−1) remaining transmit antennas.

6. The enhancer as recited in claim 1 wherein said (N−1) subsequent time intervals are contiguous.

7. The enhancer as recited in claim 1 wherein said basic and supplemental preambles are further configured to provide orthogonal gain training sequences to each of said N transmit antennas during a same subsequent time interval thereby allowing receive gains to be reconfigured for MIMO data reception.

8. The enhancer as recited in claim 1 wherein said first preamble generator and said second preamble generator are implemented separately.

9. A method of channel estimation for use with a multiple-input, multiple-output (MIMO) transmitter employing N transmit antennas, where N is at least two, comprising:
employing a basic preamble to provide gain training and channel estimation sequences to one of said N transmit antennas during initial time intervals; and
further employing supplementary preambles to provide a set of gain enhancing channel estimation sequences to each of (N−1) remaining transmit antennas during (N−1) corresponding sets of subsequent time intervals.

10. The method as recited in claim 9 wherein said set of gain enhancing channel estimation sequences employs a same set of sequences for each of said (N−1) remaining transmit antennas.

11. The method as recited in claim 9 wherein said set of gain enhancing channel estimation sequences employs a supplementary gain training sequence and a supplementary channel estimation sequence.

12. The method as recited in claim 9 wherein said set of gain enhancing channel estimation sequences employs supplementary gain training sequence and two supplementary channel estimation sequences.

13. The method as recited in claim 9 wherein said basic and supplementary preambles employ a time-switched structure that provides null sequences to all other transmit antennas when said set of gain enhancing channel estimation sequences is provided to each of said (N−1) remaining transmit antennas.

14. The method as recited in claim 9 wherein said (N−1) subsequent time intervals are contiguous.

15. The method as recited in claim 9 wherein said basic and supplemental preambles further provide orthogonal gain training sequences to each of said N transmit antennas during a same subsequent time interval thereby allowing receive gains to be reconfigured for MIMO data reception.

16. The method as recited in claim 9 wherein said gain training and channel estimation sequences of said basic preamble conform to an IEEE 802.11 standard.

17. A multiple-input, multiple-output (MIMO) communication system, comprising:
a MIMO transmitter that has N transmit antennas, where N is at least two;
a channel estimate enhancer that is coupled to said MIMO transmitter, including:
a first preamble generator that produces a basic preamble to provide gain training and channel estimation sequences to one of said N transmit antennas during initial time intervals, and
a second preamble generator, coupled to said first preamble generator, that produces supplementary preambles to provide a set of gain enhancing channel estimation sequences to each of (N−1) remaining transmit antennas during (N−1) corresponding sets of subsequent time intervals; and
a MIMO receiver that has M receive antennas, where M is at least two, and employs said set of gain enhancing channel estimation sequences to determine channel estimates.

18. The MIMO communication system as recited in claim 17 wherein said set of gain enhancing channel estimation sequences employs a same set of sequences for each of said (N−1) remaining transmit antennas.

19. The MIMO communication system as recited in claim 17 wherein said set of gain enhancing channel estimation sequences employs a supplementary gain training sequence and a supplementary channel estimation sequence.

20. The MIMO communication system as recited in claim 17 wherein said set of gain enhancing channel estimation sequences employs a supplementary gain training sequence and two supplementary channel estimation sequences.

21. The MIMO communication system as recited in claim 17 wherein said basic and supplementary preambles employ a time-switched structure that provides null sequences to all other transmit antennas when said set of gain enhancing channel estimation sequences is provided to each of said (N−1) remaining transmit antennas.

22. The MIMO communication system as recited in claim 17 wherein said (N−1) subsequent time intervals are contiguous.

23. The MIMO communication system as recited in claim 17 wherein said basic and supplemental preambles further provide orthogonal gain training sequences to each of said N transmit antennas during a same subsequent time interval thereby allowing receive gains to be reconfigured for MIMO data reception.

24. The MIMO communication system as recited in claim 17 wherein said first preamble generator and said second preamble generator are implemented separately.
